(19) United States
(12) Patent Application Publication
(10) Pub. No.: US 2005/0177540 A1
(43) Pub. Date: Aug. 11, 2005

(54) Large-scale visualization of temporal data

(76) Inventors: Mihael Ankerst, Seattle, WA (US); Anne S-W Kao, Bellevue, WA (US)

Correspondence Address: Frank J. Bozzo;BLACK LOWE & GRAHAM PLLC, Suite 4800, 701 Fifth Avenue, Seattle, WA, 98104, US

(21) Appl. No.: 10/769,066

(22) Filed: Jan. 30, 2004

(51) Int. Cl. G06F 7/00

(52) U.S. Cl. 707/1

(57) ABSTRACT

Methods, computer-readable media, and systems for representing data associable with intervals are provided. A frame is associated with each of a number of intervals in a period. The frame is configured to display a maximum number of points. A first number of points representative of a first data quantity associable with each interval is determined, wherein a proportion of the first number of points to the maximum number of points represents a relative magnitude of the first data quantity. The first number of points is contiguously displayed in the frame for each of the intervals. Additional numbers of points suitably also are displayed to represent a relative magnitude of additional data quantities associable with each interval.

### FIELD OF THE INVENTION

This invention relates generally to event monitoring and, more specifically, to collection and presentation of event data to facilitate assimilation and analysis of the event data.

### BACKGROUND OF THE INVENTION

Computers have revolutionized the ability to collect, sort, manipulate, and store data. The data processing capacities of computers have transformed industries from banking to transportation. The data processing abilities of computers have also created a universe of other industries from merchandising to communications that otherwise never would have been possible.

The evolution of display and graphics technologies emerging over the last few decades has further extended the usefulness of computers. It is well documented how much better people can assimilate data presented in the form of graphs or other visual representations as compared to how well they can assimilate the same information presented in the form of text and tables. Because even a commonplace personal computer can transform columns of numbers and text into a colorful, multidimensional graph or chart, computers not only collect, sort, manipulate, and store data, but can also help distill the information into a human-useable form.

FIG. 1 shows a conventional data-processing system 100. The system 100 typically has three principal layers: a data source layer 110, a processing layer 130, and a visualization layer 150. The data source layer 110 generally incorporates a number of data storage devices 120. The data storage devices 120 typically include one or more of direct-access storage devices (DASDs) such as hard disks, diskettes, or CD-ROMs. The processing layer 130 typically incorporates data-processing subsystems of the system 100 such as microprocessors and random access memory devices (RAM) in which operations are performed on data stored in the data source layer 110. The visualization layer 150 incorporates at least one of a display 160 or another device, such as a printer, configured to generate printed output 170. The visualization layer 150 allows raw data stored in the data source layer 110 and/or processed by the processing layer 130 to be presented to the user for review. The information displayed may include charts or graphs selected by the user to try to evaluate the content and/or meaning of the data.

FIG. 2 shows one form of data that it may be desirable to present using a data processing system such as the system 100 (FIG. 1). FIG. 2 shows a calendar month 200 which includes a number of days. For each day of the month, for example a day 210 such Jan. 28, 2002, various event data 220 may be logged in an event log, a portion 230 of which is shown in FIG. 2. Data 220 logged for the day 210 may include one or more events 240 and 250 that occurred on the day 210. In FIG. 2, the data 220 logged in the portion of the event log 230 includes a series of aircraft maintenance events 240 and 250. Each of the events 240 and 250 may include a number of fields such as a date 260, an event type 270, a code 280 indicating the type of event, a location of the event 290, and/or other data (not shown). In the data 220 shown in the portion of the event log 230, for example, for the date 260 of Jan. 28, 2002, the event type 270 may include a broken door, a tail light failure, or another event. The code 280, which might include an Air Transport Association (ATA) code or some other alphabetic, numeric, or alphanumeric coding scheme, includes one code to represent the broken door and another to indicate the tail light failure. The codes 280 listed here are “X” and “Y” but could include any suitable single-digit or multiple-digit coding scheme. The location 290 includes Seattle, Chicago, or another location.

Using the processing layer 130 (FIG. 1), the data 220 stored in the portion of the event log 230 may be correlated by data 260, event type 270, code 280, and/or location 290 to generate reports. Reports might be created to tally how many events of each type transpired to determine if original parts may be failing too frequently. Alternatively, the reports might be developed to help human analysts interpret what type of parts inventory and personnel and/or skills are needed, where the parts are needed, and when.

To better distill frequency of event types, trends, or other information from the data 220 stored in the portion of the event log 230, it may be desirable to generate a chart or a graph. FIG. 3, for example, shows a bar graph 300 that may be generated from the event data 220. The bar graph 300 may collect a number of events 240 and 250 (FIG. 2) that have taken place according to a number of event types 270 or codes 280 or for a day 210, a month 200, or another period of time.

The graph 300 shows a number of events 310 listed according to event type, including events collected for categories such as doors 320, engines 330, electronics 340, and lights 350. The graph 300 may show a number of events for the different categories 320, 330, 340, and 350 for an hour, a day, a week, a month, a year, or another unit of time. Thus, the graph 300 pictorially or graphically represents series of events that have taken place.

Whether the information is useful to a human analyst may depend on what the human analyst seeks to discern from the data represented. For example, if the human analyst is seeking to identify trends, such as times or dates when these events tend to peak, the graph 300 may not be particularly useful. Hypothetically, if graphs 300 were generated for the different categories 320, 330, 340 and 350 for every day of one or more years, the human analyst would have to compare hundreds upon hundreds of graphs looking for trends. Considered in this context, the graphs that might have been relatively useful to compare event totals when looking at one graph or a few graphs at a time now are no longer nearly as helpful.

FIG. 3B illustrates another conventional way of visualizing data, such as data which may be distilled from a portion of an event log 230. More particularly, FIG. 3B shows a line graph 355 that might be used for viewing numbers of occurrences or other measurements occurring over time. The line graph 355 suitably includes one or more lines 360, 370, 380, and 390, each of which recounts a status of a different measurement over time. Although a legend 395 might be included to clarify which of the lines 360, 370, 380, and 390 depicts which measurement, from FIG. 3B one can appreciate that, especially as more and more measurements are added, or more and more graphs 355 are presented the data represented by such a graph 355 may be difficult to assimilate.

Thus, there is an unmet in the art for graphically presenting time-related data spanning long periods of time to facilitate enhanced analysis of the data.

### SUMMARY OF THE INVENTION

Embodiments of the present invention allow for a user to more readily view data associable with intervals of time in a period. By representing data quantities, such as numbers of occurrences related to an interval or other measurements associable with the interval, in a frame format, analysts can more readily view data thereby represented. In each frame, a number of points representative of one or more data quantities associated with each interval presents a relative representation of a magnitude of the data quantity for each interval relative to a size of the frame. Using embodiments of the present invention, analysts can readily view, detect, and assess patterns that may emerge from data quantities presented in such a format. Moreover, the frames suitably are presented in a calendar-style format. Such a format is a familiar metaphor allowing an analyst to better appreciate how events of interest or concern may correlate with seasons, parts of weeks, parts of months, holidays, or other periodic events which an analyst may intuitively appreciate.

More particularly, embodiments of the present invention provide methods, computer-readable media and systems for representing data associable with intervals. A frame is associated with each of a number of intervals in a period. The frame is configured to display a maximum number of points. A first number of points representative of a first data quantity associable with each interval is determined, wherein a proportion of the first number of points to the maximum number of points represents a relative magnitude of the first data quantity. The first number of points is contiguously displayed in the frame for each of the intervals. Additional numbers of points suitably also are displayed to represent a relative magnitude of additional data quantities associable with each interval.

In accordance with an aspect of the present invention, each of the intervals includes at least a portion of a day. When the interval includes a day, the period includes at least one week such that the frames are presented in a week table. The week table lists days along a first axis and days of a week listed along a second axis. Alternatively, the period includes at least one month such that the frames are presented in a month table. The month table lists days of the week along a first axis and weeks along a second axis. The period suitably includes at least one year such that the frames presented in a plurality of month tables.

In accordance with additional aspects of the present invention, each of the number of points includes at least one pixel. Also, the data quantity may include a number of occurrences and the first number of points represents a number of occurrences. Alternatively, the data quantity includes at least one measurement and the first number of points represents a magnitude of the measurement. The measurement may include at least one of a longest streak of recorded occurrences, longest streak without recorded occurrences, and greatest deviation from an average of occurrences.

Additionally, according to other aspects of the present invention, a proportion of the first number of points to the maximum number of points approximately equals a proportion of the first data quantity to a first data quantity limit. The first data quantity may be approximately equated to the maximum number of points. Alternatively, the first data quantity limit may be approximately equated to a maximum of the first data quantity for the period.

In accordance with further aspects of the present invention, the first number of data points is presented in a first format. The first format may include at least one of a color, a shade of gray, and a fill pattern. The first format may be user-selectable.

Also in accordance with embodiments of the present invention, a second number of points is determined, where the second number of points is representative of a second data quantity associable with each interval. A proportion of the second number of points to the maximum number of points approximately represents a relative magnitude of the second data quantity. The second number of points is contiguously displayed in the frame for each of the intervals such that the second number of points does not obscure the first number of points. The maximum number of display points may be equated to a total of a first data quantity limit and a second data quantity limit. The second data quantity limit approximately may be set to a maximum of the second data quantity for the period. The second number of data points is presented in a second format including at least one of a color, a shade of gray, and a fill pattern. The second format may be user-selectable, with the second format being either the same as or different from the first format.

Similarly, a plurality of additional numbers of points representative of a plurality of additional data quantities associable with each interval may be determined. A proportion of each of the additional numbers of points to the maximum number of points approximately represents a relative magnitude of each of the plurality of additional data quantities. The plurality of additional numbers of points are contiguously displayed in the frame for each of the intervals such that the additional numbers of points do not obscure the first number of points or any of the additional numbers of points.

### BRIEF DESCRIPTION OF THE DRAWINGS

The preferred and alternative embodiments of the present invention are described in detail below with reference to the following drawings.

FIG. 1 is a block diagram of a conventional data system for tracking event data;

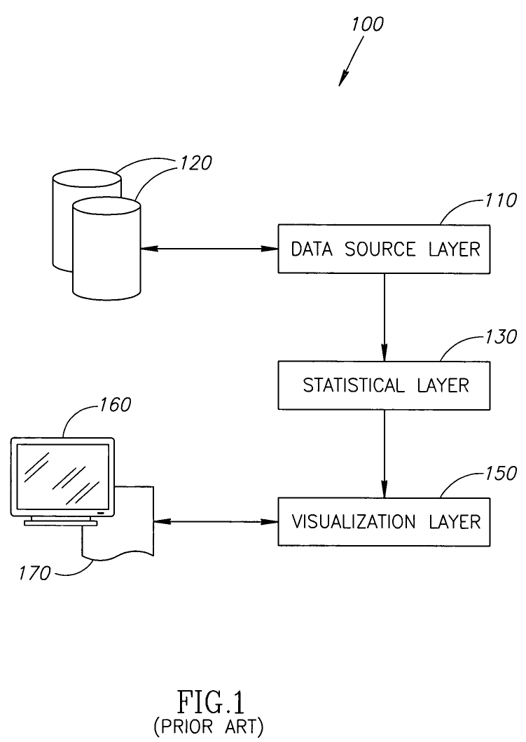

FIG. 2 is a representative month and a portion of a conventional event log for a day of the representative month;

FIG. 3A is the portion of the conventional event log of FIG. 2 and a conventional bar graph representing entries in the event log;

FIG. 3B is the portion of the conventional event log of FIG. 2 and a conventional line graph representing entries in the event log;

FIG. 4 is a portion of an event log storing events of a single type and a representation of events for a day from the event log according to an embodiment of the present invention;

FIG. 5 is the representation of FIG. 4 shown as part of a calendar month;

FIG. 6 is the representation of FIG. 4 shown as part of a calendar week along with representations of event logs for other days of a week according to an embodiment of the present invention;

FIG. 7 is a review period including a number of months using representations of occurrences of a single type of event according to an embodiment of the present invention;

FIG. 8 is the portion of the event log of FIG. 2 and a representation of the event log according to an embodiment of the present invention for representing multiple events;

FIG. 9 is a representative month including the representation of FIG. 8;

FIG. 10 is a review period including a number of months using representations of occurrences of multiple types of events according to an embodiment of the present invention;

FIG. 11 is the review period of FIG. 10 and a user-interface allowing a user to assign or reassign a depiction format assigned to types of events being represented;

FIG. 12 is a flowchart of a routine according to an embodiment of the present invention; and

FIG. 13 is a block diagram of an exemplary system according to an embodiment of the present invention.

### DETAILED DESCRIPTION OF THE INVENTION

By way of overview, embodiments of the present invention provide methods, computer-readable media and systems for representing data associable with intervals. A frame is associated with each of a number of intervals in a period. The frame is configured to display a maximum number of points. A first number of points representative of a first data quantity associable with each interval is determined, wherein a proportion of the first number of points to the maximum number of points represents a relative magnitude of the first data quantity. The first number of points is contiguously displayed in the frame for each of the intervals. Additional numbers of points suitably also are displayed to represent a relative magnitude of additional data quantities associable with each interval.

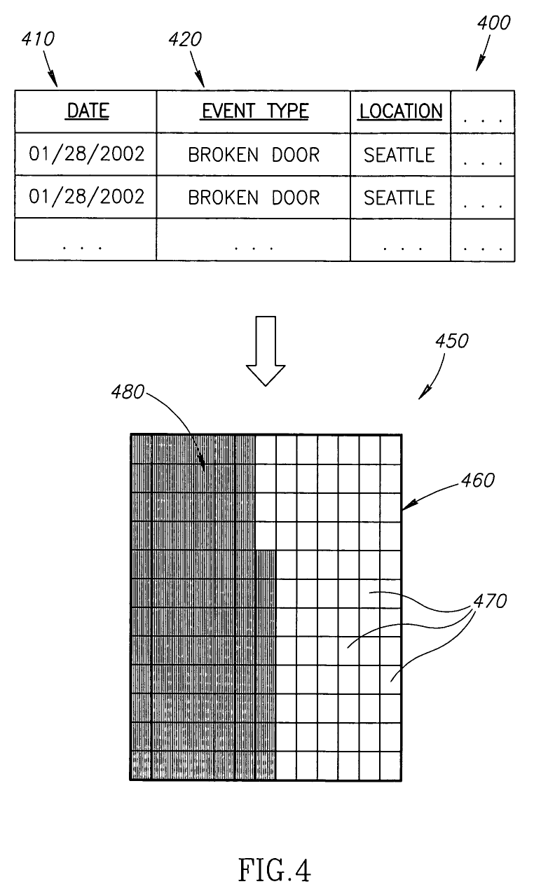

FIG. 4 shows a portion of an event log 400 storing events of a single type and a representation 450 of events for a day from the event log according to an exemplary, non-limiting embodiment of the present invention. The events of a single type actually include only events of a single type or include a group of events elected to be presented as a single, composite type. In the example illustrated in FIG. 4, the interval is a day associated with a frame 460. In particular, the day is Jan. 28, 2004, a date 410 covered by the event log 400. An event type 420 depicted in the event log 400 is “Broken Door.” A number of “Door Broken” events is a data quantity being evaluated using an embodiment of the present invention for a number of days in a period. Because the interval is a day, the period suitably includes a plurality of days, one or more weeks, one or more months, or one or more years, or other periods of potential interest.

The frame 460 is configured to display a maximum number of points 470. Each of the points suitably includes one or more pixels or another suitable subdivision of a displayable medium. A shaded area 480 of the frame 460 is an aggregation of a number of points 470 used to display the data quantity being represented. The points 470 in the shaded area 480 suitably are presented contiguously.

The data quantity represented, a number of instances logged as involving a “Broken Door” in this example, are counted or collected from a log, database, or other data repository. The data quantity is represented as a number of points 470 included in the shaded area 480. The shaded area 480 in proposition to the frame 460 as a whole represents a relative magnitude of the data quantity being represented for the interval relative to a data quantity limit. The data quantity limit suitably is approximately equated with a maximum number of points 470 within the frame 460. Thus, in one presently preferred embodiment, equation (1) shows how the shaded area 480 represents the data quantity being represented:

$$\frac{Data Quantity Represented}{Data Quantity Limit} = \frac{Number Of Points In Shaded Area}{Maximum Number Of Points In Frame} \qquad ( 1 )$$

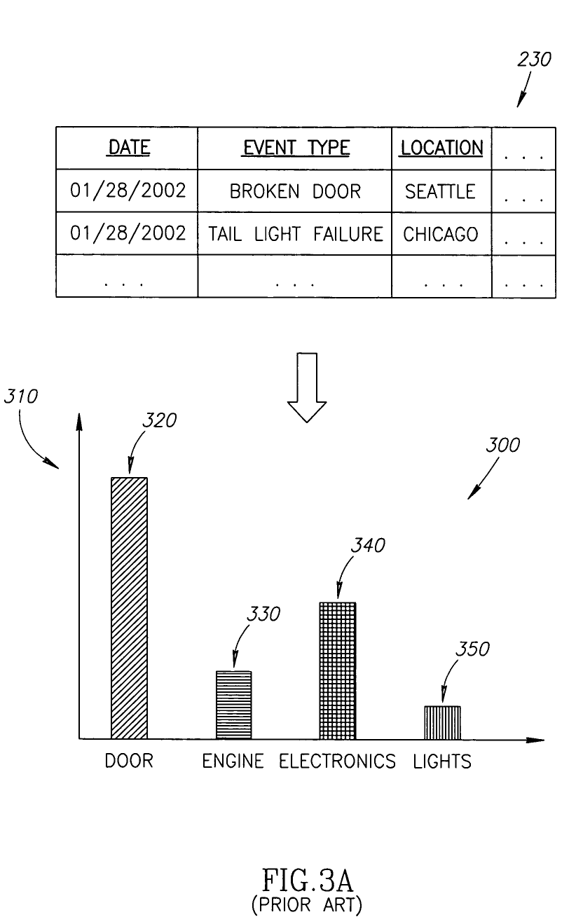

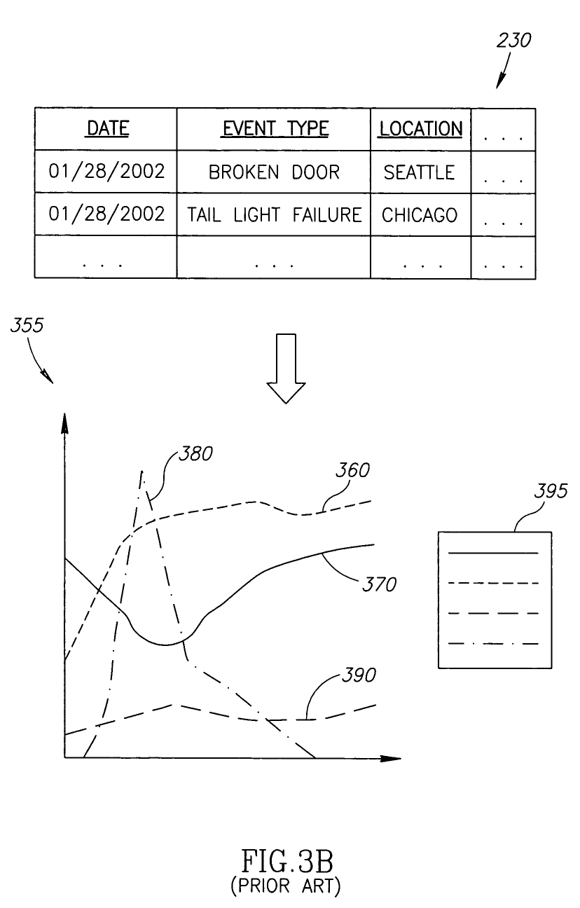

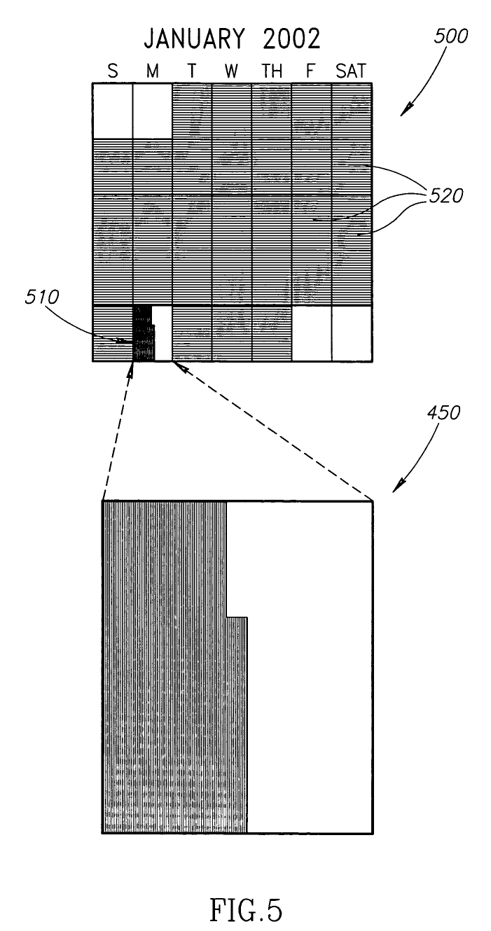

The representation 450 provides a way of viewing the data quantity that differs from the way afforded by the bar graph 300 (FIG. 3). In the bar graph 300, each of the bars representing events occurring in each of the categories 320, 330, 340, and 350 effectively are measured against a unitized vertical axis. Each of the bars thus indicates a relative magnitude of the quantity expressed by each by comparing the height of the bar to the vertical axis. In the representation 450, a proportion of points 470 in the shaded area 480, as opposed to points in the nonshaded area 490, indicate a relative magnitude of the data quantity represented. The representation 450 provides benefits over the graph 300 particularly when viewing the data quantity represented over time as shown in FIG. 5.

FIG. 5 shows the representation 450 of FIG. 4 shown as part of a calendar month 500. The representation 450 is miniaturized to a scaled representation 510. Similar representations can be generated for each day 520 in the calendar month. As compared to the graph 300 (FIG. 3) which expresses relative magnitude of a data quantity being represented with a vertical bar, the representation 450 and its miniaturization 510 show the relative magnitude of the data quantity in two dimensions. It will be appreciated that using both dimensions of the frame 460 (FIG. 4) makes the relative magnitude of the data quantity represented easier to discern.

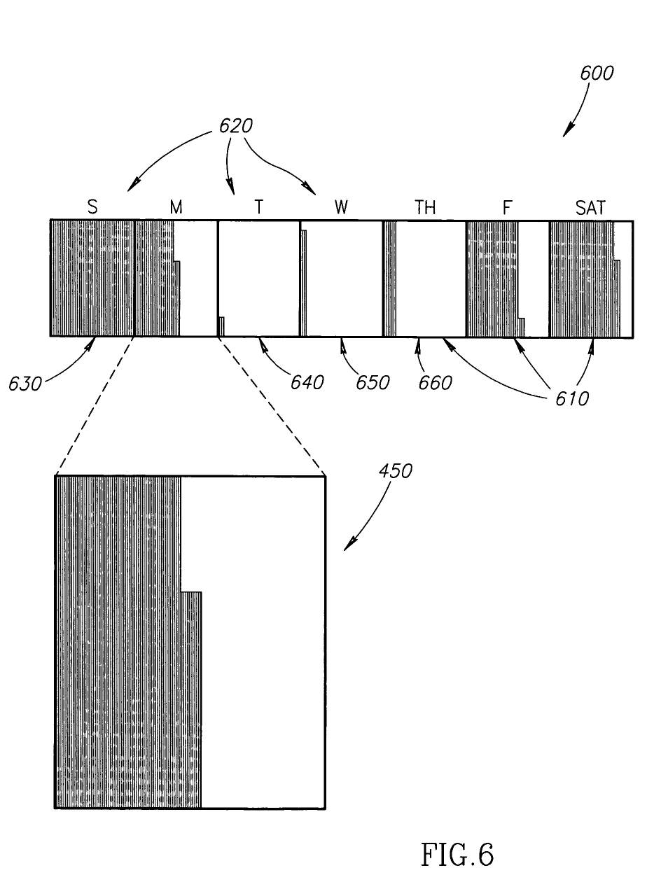

FIG. 6 is the representation 450 of FIGS. 4 and 5 shown as part of a calendar week 600 along with representations 610 of event logs (not shown) for other days of a week 620 according to an embodiment of the present invention. As can be seen from FIG. 6, the calendar week 600 allows an analyst to discern variances in the data quantity being represented between days 620. For example, one can see that the data quantity represented, whether a “Broken Door” or another quantity, is at a maximum on Sunday 630, decreasing to a minimum on Tuesday 640, and increasing Wednesday 650 and Thursday 660 to and through the weekend. With such information, an analyst can identify trends and, thus, can better assess parts and repair and/or replacement skills that might be needed on days of higher occurrences versus days having lower occurrences.

FIG. 6 shows the days of a week listed along a first, horizontal axis and a week, which could be any number of weeks, listed along a second, vertical axis. It will be appreciated that the axes could be reversed to accommodate preferences or other concerns.

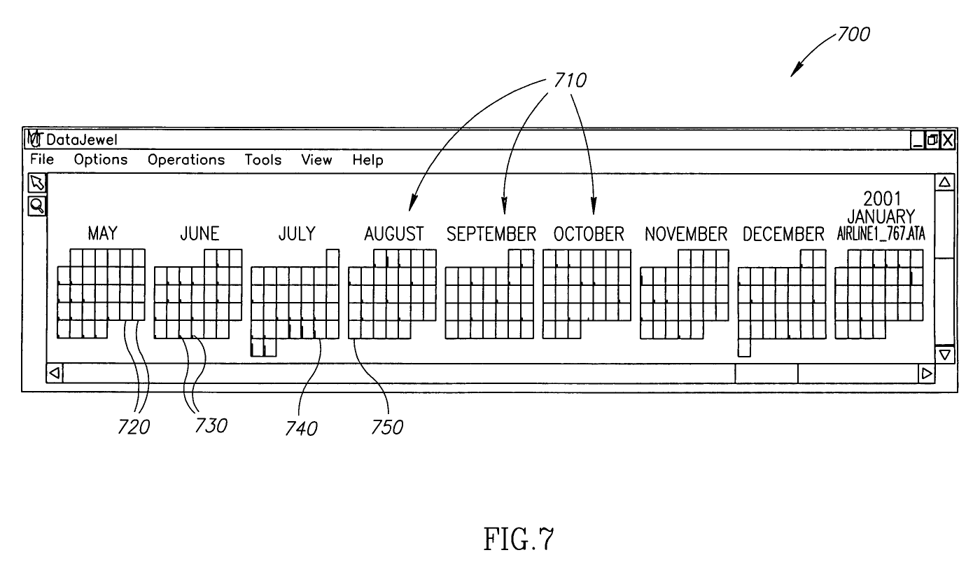

FIG. 7 is a review period 700 including a number of months 710 using representations of occurrences of a single type of event according to an embodiment of the present invention. Viewing the review period can make clear several benefits of representing data quantities according to embodiments of the present invention. At a glance, an analyst can discern days on which represented events have not occurred 720 from days on which represented events have occurred 730. Moreover, an analyst not only can determine on which days represented events have occurred 730, but the analyst also can differentiate days having low numbers of occurrences 740 from days having high number of occurrences 750. Even in a year-long view 700, analysts and researchers can discern such useful information.

Embodiments of the invention can be adapted to a variety of applications. As has been described in connection with FIGS. 4 through 7, the interval suitably includes a day. Where the interval includes a day, the period suitably includes a week wherein the days are presented in one or more week tables listing days along a first axis and days of the week along a second axis. Also, the period suitably includes a month wherein the days are presented in one or more month tables listing weeks along a first axis and days of the week along a second axis. Alternatively, the interval could be a portion of day, such as a minute or an hour, or a group of days. Correspondingly, if the interval is an hour, for example, the period could be a day.

In embodiments of the present invention, each of the number of points suitably includes at least one pixel, or can include a group of pixels. In any case, the points suitably represent occurrences and the number of points represents a number of occurrences. The number of points may literally equal the number of occurrences, or alternatively, the ratio of points to the maximum number of points may represent a relative proportion of the data quantity to a data quantity limit. Alternatively, the data quantity suitably includes a measurement, such as a longest streak of occurrences, a longest streak without recorded occurrences, a greatest deviation from an average, or any other measurement that might be associated with an interval.

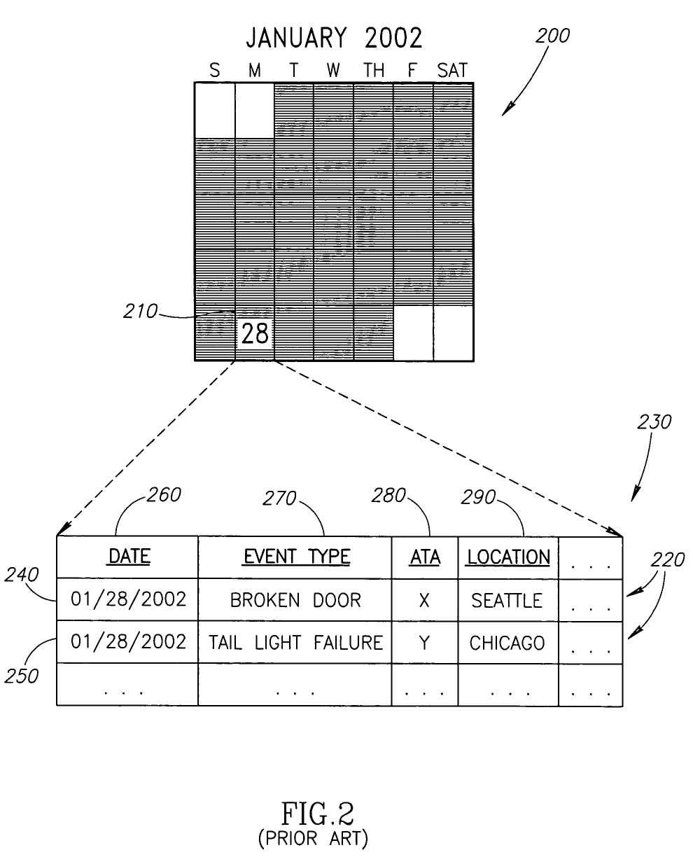

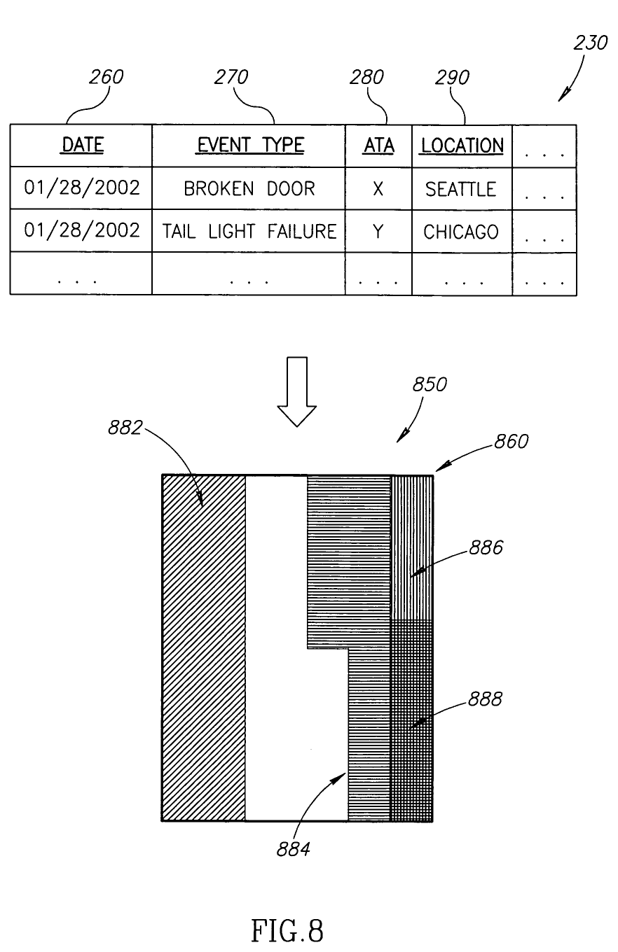

FIG. 8 is the portion of the event log 230 of FIG. 2 and a representation 850 of the event log according to an embodiment of the present invention for representing multiple events. In the example illustrated in FIG. 8, the interval is a day associated with a frame 860. In particular, the day is Jan. 28, 2002, the date 280 covered by the portion of the event log 230. The portion of the event log 230 shows events of multiple types, including “Broken Door,” “Tail Light Failure,” etc. As events of a single type can be illustrated in the representation 450 (FIG. 4), events of multiple types also can be illustrated.

The representation 850 shows representations of the four different event types shown in the graph 300 (FIG. 3) including door 320, engine, 330, electronics 340, and lights 350. According to one embodiment of the invention, each of the event types 320, 330, 340, and 350 is shown in a different visual format such that each event type can be visually discerned from another. The formats suitably include different colors, shades, fill patterns, or other forms of visual differentiation.

The frame 460, like the frame 860 (FIG. 4) is configured to display a maximum number of points. Each of the points suitably includes one or more pixels or another suitable subdivision of a displayable medium. Shaded areas 882, 884, 886, and 888 of the frame 860 are aggregations of a number of points used to display the data quantities being represented. The points in each of the shaded areas 882, 884, 886, 88 suitably are presented contiguously.

The data quantities represented, a number of instances logged as involving a “Broken Door,” “Tail Light Failure,” etc., are counted or collected from a log, database, or other data repository. The data quantities are represented as numbers of points included in the shaded areas 882, 884, 886, 888. The shaded areas 882, 884, 886, and 888 in proportion to the frame 860 as a whole represents a relative magnitude of each the data quantities being represented for the period relative to data quantity limits. The total of the data quantity limits suitably is approximately equated with a maximum number of points within the frame 860. Alternatively, because of a relative scarcity of one type of occurrence as compared to another, the data quantity limit for one type of event may be scaled relative to others to optimize visualization of the representation 850 according to desired parameters.

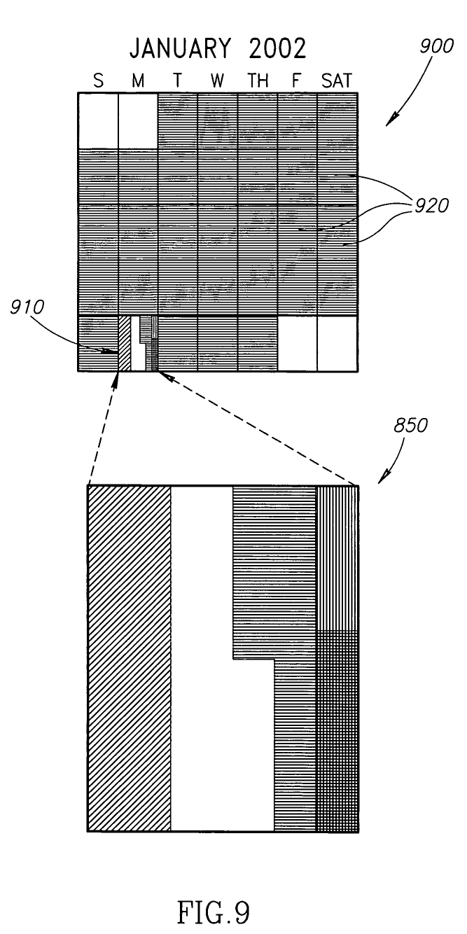

FIG. 9 is a representative month 900 including the representation 850 of FIG. 8. The representation 850 is miniaturized to a scaled representation 910. Similar representations can be generated for each day 920 in the calendar month. As compared to the graph 300 (FIG. 3) which expresses relative magnitudes of data quantities being represented with a vertical bar, the representation 850 and its miniaturization 910 show the relative magnitudes of the data quantities in two dimensions. It will be appreciated that using both dimensions of the frame 860 (FIG. 8) makes the relative magnitudes of the data quantities represented easier to discern.

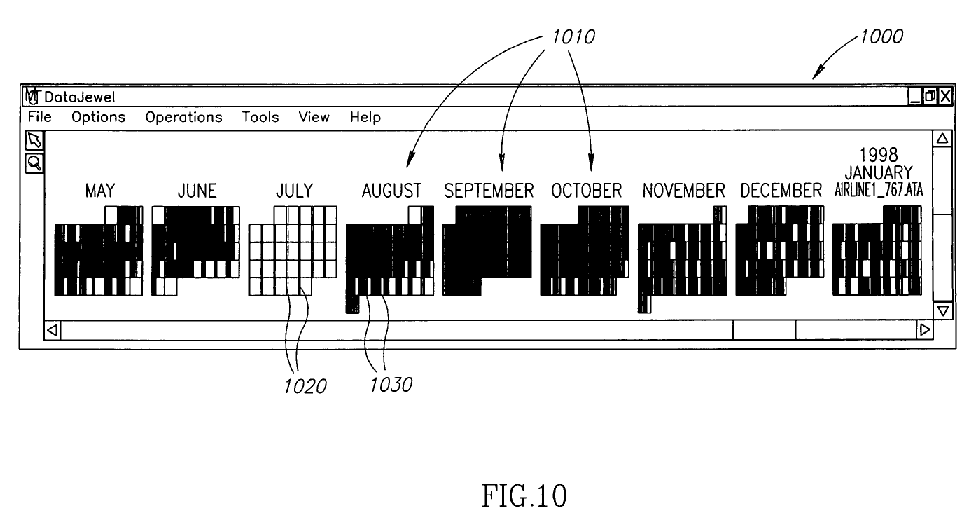

FIG. 10 is a review period 1000 including a number of months 1010 using representations of occurrences of multiple types of events according to an embodiment of the present invention. At a glance, an analyst can discern days on which represented no or few represented events of any type have occurred 1020 from days on which represented events of many types have occurred 1030. Even in a year-long view 1000, analysts and researchers can discern such useful information for identifying trends for forensic analysis, planning, and other purposes.

It will be appreciated that the maximum number of display points suitably may be equated to a total of a first data quantity limit and a second data quantity limit. Alternatively, the portion of available points equated with, for example, a first data quantity limit and a second data quantity limit may be associated with desired proportions of the maximum number of points. It will be appreciated that embodiments of the present invention are not limited to displaying only two such data quantities. Any number of data quantities suitably are represented.

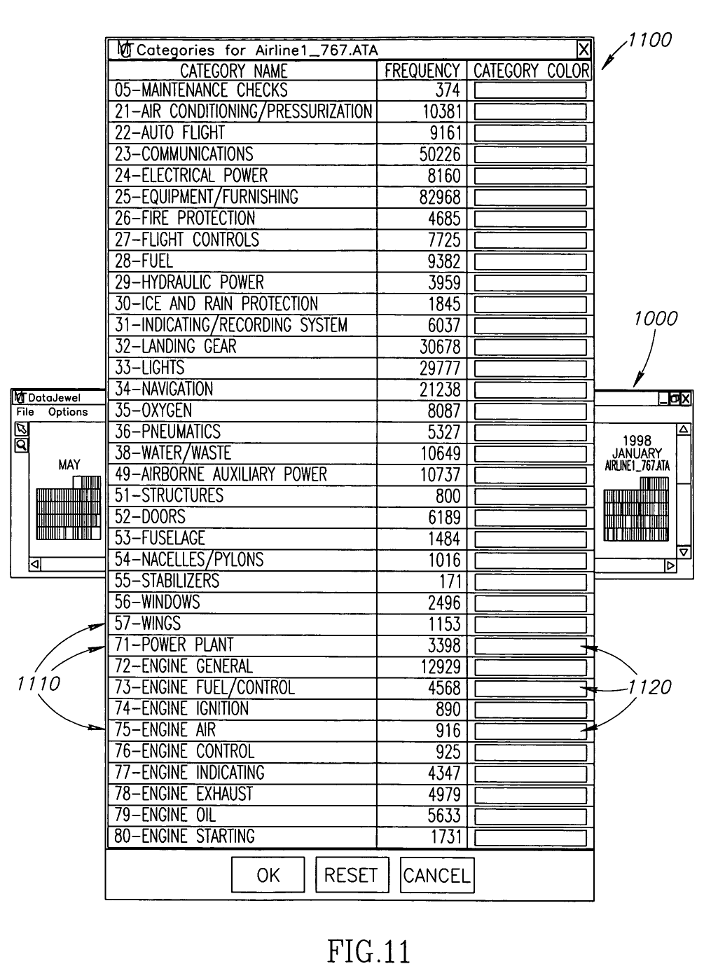

FIG. 11 is the review period 1000 of FIG. 10 and a user-interface 1100 allowing a user to assign or reassign a depiction format assigned to types of events being represented. In the representations collected in the review period 1000, the event types are represented by formats comprising different shades. As previously described, the formats suitably include different shades, colors, fill patterns, or other manners of visual differentiation. The user-interface associates various event types 1110 with different format types 1120. Using the interface 1100, a user can choose formats 1120 assigned to the event types 1110. Therefore, for example, if a user wants to make one particular type of event stand out, the user can assign a very different format for it from the other formats being used. For a further example, if a user wanted to aggregate events of similar types they could be assigned a single, common format. Embodiments of the present invention are not limited to any particular selection of format.

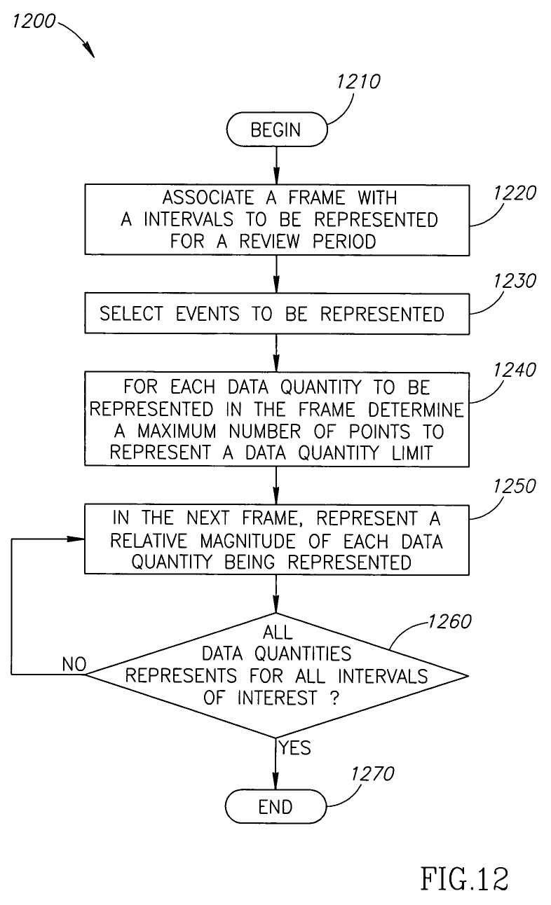

FIG. 12 is a flowchart of a routine 1200 according to an embodiment of the present invention. The routine 1200 begins at a block 1210. At a block 1220 a frame is associated with intervals to be represented for a review period. At a block 1230 data quantities to be represented in the frames are selected. At a block 1240 a maximum number of points is equated with a data limit for the group of events for each data quantity to be represented. At a block 1250 in a next frame a relative magnitude of each data quantity is represented with a contiguous number of points as previously described. At a decision block 1260 it is determined if all data quantities for all intervals of interest have been represented. If not, the routine 1200 loops to the block 1250 for the data quantities to be represented in a next frame. If so, the routine 1200 proceeds to a block 1270 where the routine 1200 ends.

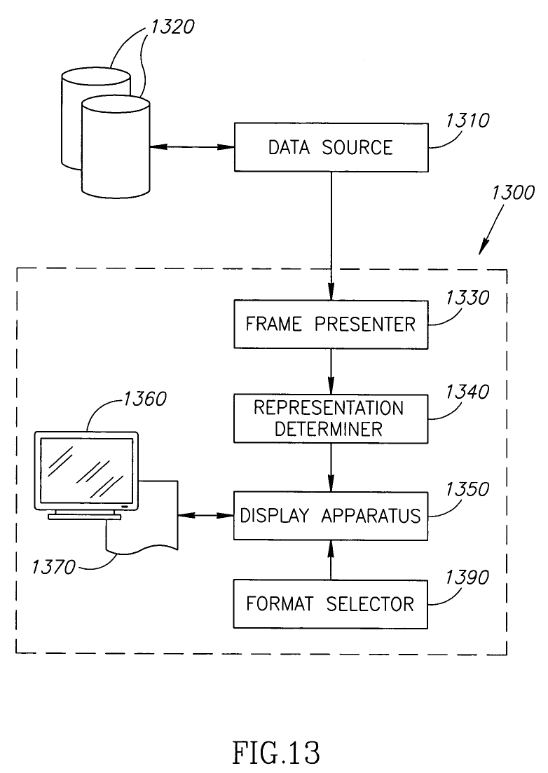

FIG. 13 shows a system 1300 according to an embodiment of the present invention. Information concerning data quantities is accessible from a data source 1310. The data source 1310 suitably accesses or includes data storage 1320 where the information is stored. The data source 1310 is accessed by a frame presenter 1330 configured to associate a frame with each of a number of intervals in a period of interest. The frame presenter 1330 suitably is configured to display a maximum number of points for each of the intervals. A representation determiner 1340 engages the frames and is configured to determine a number of points representative of each data quantity associable with each interval. As previously described, a proportion of the number of points to the maximum number of points represents a relative magnitude of the first data quantity. A display apparatus 1350 presents the number of points contiguously in the frames corresponding with each of the intervals. The display apparatus 1350 engages a display device 1360, an output device 1370 such as a printer, or another form of output device to present the frames to a user, analyst, or other person desiring to review the frames. In one presently preferred embodiment, a format selector 1390 provides an interface such as the interface 1100 (FIG. 11) allowing the formats to be assignable to represent the data quantities to isolate, aggregate, or otherwise support analysis of the data quantities represented.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A method for representing data associable with intervals, the method comprising:
associating a frame with each of a number of intervals in a period, the frame being configured to display a maximum number of points;
determining a first number of points representative of a first data quantity associable with each interval, wherein a proportion of the first number of points to the maximum number of points represents a relative magnitude of the first data quantity; and
contiguously displaying the first number of points in the frame for each of the intervals.

2. The method of claim 1, wherein each of the intervals includes at least a portion of a day.

3. The method of claim 2, wherein the interval includes a day and the period includes at least one week such that the frames are presented in a week table having days listed along a first axis and days of a week listed along a second axis.

4. The method of claim 2, wherein the interval includes a day and the period includes at least one month such that the frames are presented in a month table having days of a week listed along a first axis and at least one week listed along a second axis.

5. The method of claim 4, wherein the interval includes a day and the period includes at least one year such that the frames presented in a plurality of month tables.

6. The method of claim 1, wherein the data quantity includes a number of occurrences and the first number of points represents a number of occurrences.

7. The method of claim 1, wherein the data quantity includes at least one measurement and the first number of points represents a magnitude of the measurement.

8. The method of claim 1, wherein a proportion of the first number of points to the maximum number of points approximately equals a proportion of the first data quantity to a first data quantity limit.

9. The method of claim 1, further comprising approximately equating the first data quantity limit to the maximum number of points.

10. The method of claim 9, further comprising approximately equating the first data quantity limit to a maximum of the first data quantity for the period.

11. The method of claim 1, wherein the first number of data points is presented in a first format including at least one of a color, a shade of gray, and a fill pattern.

12. The method of claim 11, wherein the first format is user-selectable.

13. The method of claim 1, further comprising:
determining a second number of points representative of a second data quantity associable with each interval wherein a proportion of the second number of points to the maximum number of points approximately represents a relative magnitude of the second data quantity; and
contiguously displaying the second number of points in the frame for each of the intervals such that the second number of points does not obscure the first number of points.

14. The method of claim 13, further comprising approximately equating the maximum number of display points to a total of a first data quantity limit and a second data quantity limit.

15. The method of claim 14, wherein the second data quantity limit approximately is set to a maximum of the second data quantity for the period.

16. The method of claim 14, wherein the second number of data points is presented in a second format including at least one of a color, a shade of gray, and a fill pattern, wherein the second format is user-selectable and is one of the same as the first format or different from the first format.

17. The method of claim 1, further comprising:
determining a plurality of additional numbers of points representative of a plurality of additional data quantities associable with each interval wherein a proportion of each of the additional numbers of points to the maximum number of points approximately represents a relative magnitude of each of the plurality of additional data quantities; and
contiguously displaying the plurality of additional numbers of points in the frame for each of the intervals such that the additional numbers of points do not obscure the first number of points or any of the additional numbers of points.

18. A method for representing data associable with intervals, the method comprising:
associating a frame with each of a number of intervals in a period, the frame being configured to display a maximum number of points;
determining a number of points representative of each of a plurality of data quantities associable with each interval, wherein a proportion of each of the numbers of points to the maximum number of points approximately represents a relative magnitude of each of the data quantities; and
contiguously displaying each of the numbers of points in the frame for each of the intervals such that none of the numbers of points obscure others of the numbers of points.

19. The method of claim 18, wherein each of the intervals includes at least a portion of a day.

20. The method of claim 19, wherein the interval includes a day and the period includes at least one week such that the frames are presented in a week table having days listed along a first axis and days of a week listed along a second axis.

21. The method of claim 19, wherein the interval includes a day and the period includes at least one month such that the frames are presented in a month table having days of a week listed along a first axis and at least one week listed along a second axis.

22. The method of claim 21, wherein the interval includes a day and the period includes at least one year such that the frames presented in a plurality of month tables.

23. The method of claim 18, wherein at least one of the data quantities includes a number of occurrences and a corresponding number of display points represents a number of occurrences.

24. The method of claim 18, wherein at least one of the data quantities includes at least one measurement and a corresponding number of the display points represents a magnitude of the measurement.

25. The method of claim 18, wherein a proportion of each of the numbers of points to the maximum number of points approximately equals a proportion of the data quantity represented to a corresponding data quantity limit.

26. The method of claim 18, wherein each of the numbers of points is represented in a format including at least one of a color, a shade of gray, and a fill pattern.

27. The method of claim 26, wherein the format is user-selectable and is one of the same as formats used for others of the numbers of points, the same as a format used for at least another of the numbers of points, and different from the formats used for others of the numbers of points.

28. A computer-readable medium having stored thereon instructions for representing data associable with intervals, the computer-readable medium comprising:
first computer program code means for associating a frame with each of a number of intervals in a period, the frame being configured to display a maximum number of points;
second computer program code means for determining a first number of points representative of a first data quantity associable with each interval, wherein a proportion of the first number of points to the maximum number of points approximately represents a relative magnitude of the first data quantity; and
third computer program code means for contiguously displaying the first number of points in the frame for each of the intervals.

29. The computer-readable medium of claim 28, wherein each of the intervals includes at least a portion of a day.

30. The computer-readable medium of claim 29, wherein the interval includes a day and the period includes at least one week such that the frames are presented in a week table having days listed along a first axis and days of a week listed along a second axis.

31. The computer-readable medium of claim 29, wherein the interval includes a day and the period includes at least one month such that the frames are presented in a month table having days of a week listed along a first axis and at least one week listed along a second axis.

32. The computer-readable medium of claim 31, wherein the interval includes a day and the period includes at least one year such that the frames presented in a plurality of month tables.

33. The computer-readable medium of claim 28, wherein the data quantity includes a number of occurrences and the first number of points represents a number of occurrences.

34. The computer-readable medium of claim 28, wherein the data quantity includes at least one measurement and the first number of points represents a magnitude of the measurement.

35. The computer-readable medium of claim 28, wherein a proportion of the first number of points to the maximum number of points approximately equals a proportion of the first data quantity to a first data quantity limit.

36. The computer-readable medium of claim 28, further comprising fourth computer program code means for approximately equating the first data quantity limit to the maximum number of points.

37. The computer-readable medium of claim 36, further comprising fifth computer program code means for approximately equating the first data quantity limit to a maximum of the first data quantity for the period.

38. The computer-readable medium of claim 28, further comprising sixth computer program code means for presenting the first number of data points in a first format including at least one of a color, a shade of gray, and a fill pattern.

39. The computer-readable medium of claim 38, further comprising seventh computer program code means for selecting the first format.

40. The computer-readable medium of claim 28, further comprising:
eighth computer program code means for determining a second number of points representative of a second data quantity associable with each interval wherein a proportion of the second number of points to the maximum number of points approximately represents a relative magnitude of the second data quantity; and
ninth computer program code means for contiguously displaying the second number of points in the frame for each of the intervals such that the second number of points does not obscure the first number of points.

41. The computer-readable medium of claim 40, further comprising tenth computer program code means for approximately equating the maximum number of display points to a total of a first data quantity limit and a second data quantity limit.

42. The computer-readable medium of claim 41, wherein the second data quantity limit approximately is set to a maximum of the second data quantity for the period.

43. The computer-readable medium of claim 42, further comprising eleventh computer program code means for presenting the second number of data points in a second format including at least one of a color, a shade of gray, and a fill pattern, wherein the second format is user-selectable and is one of the same as the first format and different from the first format.

44. The computer-readable medium of claim 28, further comprising:
twelfth computer program code means for determining a plurality of additional numbers of points representative of a plurality of additional data quantities associable with each interval wherein a proportion of each of the additional numbers of points to the maximum number of points approximately represents a relative magnitude of each of the plurality of additional data quantities; and
thirteenth computer program code means for contiguously displaying the plurality of additional numbers of points in the frame for each of the intervals such that the additional numbers of points do not obscure the first number of points or any of the additional numbers of points.

45. A system for representing data associable with intervals, the system comprising:
a frame presenter configured to associate a frame with each of a number of intervals in a period, the frame presenter being configured to display a maximum number of points for each of the intervals a representation determiner configured to determine a first number of points representative of a first data quantity associable with each interval, wherein a proportion of the first number of points to the maximum number of points represents a relative magnitude of the first data quantity; and
a display apparatus configured to contiguously display the first number of points in the frame for each of the intervals.

46. The system of claim 45, wherein each of the intervals includes at least a portion of a day.

47. The system of claim 46, wherein the interval includes a day and the period includes at least one week such that the frame presenter is configured to present in a week table days listed along a first axis and days of a week listed along a second axis.

48. The system of claim 46, wherein the interval includes a day and the period includes at least one month such that the frame presenter is configured to present in a month table days of a week listed along a first axis and at least one week listed along a second axis.

49. The system of claim 48, wherein the interval includes a day and the period includes at least one year such that the frames presenter is configured to present a plurality of month tables.

50. The system of claim 45, wherein the data quantity includes a number of occurrences and the representation determiner is configured to generate a first number of points representing a number of occurrences.

51. The system of claim 45, wherein the data quantity includes at least one measurement and the representation determiner is configured to generate a first number of points representing a magnitude of the measurement.

52. The system of claim 45, wherein the representation determiner is configured to generate a first number of points by generally equating a proportion of the first number of points to the maximum number of points to a proportion of the first data quantity to a first data quantity limit.

53. The system of claim 45, wherein the representation determiner is further configured to approximately equate the first data quantity limit to the maximum number of points.

54. The system of claim 53, wherein the representation determiner is further configured to approximately equate the first data quantity limit to a maximum of the first data quantity for the period.

55. The system of claim 45, wherein the display apparatus is further configured to present a first number of data points in a first format including at least one of a color, a shade of gray, and a fill pattern.

56. The system of claim 55, further comprising a format selector coupled with the display apparatus, the format selector allowing a user to select the first format.

57. The system of claim 45, wherein:
the representation determiner is further configured to determine a second number of points representative of a second data quantity associable with each interval wherein a proportion of the second number of points to the maximum number of points approximately represents a relative magnitude of the second data quantity; and
the display apparatus is further configured to contiguously display the second number of points in the frame for each of the intervals such that the second number of points does not obscure the first number of points.

58. The system of claim 57, wherein the representation determiner is further configured to approximately equate the maximum number of display points to a total of a first data quantity limit and a second data quantity limit.

59. The system of claim 58, wherein the representation determiner is further configured to set the second data quantity limit approximately equal to a maximum of the second data quantity for the period.

60. The system of claim 57, wherein the display apparatus is further configured to present the second number of data points in a second format including at least one of a color, a shade of gray, and a fill pattern wherein the second format is user-selectable and the second format is one of the same as the first format and different from the first format.

61. The system of claim 45, wherein:
the representation determiner is further configured to determine a plurality of additional numbers of points representative of a plurality of additional data quantities associable with each interval wherein a proportion of each of the additional numbers of points to the maximum number of points approximately represents a relative magnitude of each of the plurality of additional data quantities; and
the display apparatus is further configured to contiguously display the plurality of additional numbers of points in the frame for each of the intervals such that the additional numbers of points do not obscure the first number of points or any of the additional numbers of points.

62. The system of claim 45, wherein the display apparatus includes one of a display screen and at least one printer.
